(19) United States
(12) Patent Application Publication
(10) Pub. No.: US 2009/0144155 A1
(43) Pub. Date: Jun. 4, 2009

(54) VEHICULAR ADVERTISEMENT SYSTEM AND METHOD

(76) Inventors: Joni Jeanette Lora, Issaquah, WA (US); Douglas Alan Lora, Issaquah, WA (US)

Correspondence Address: AXIOS LAW GROUP. PLLC, 1525 4TH AVE, STE 800, SEATTLE, WA, 98101-1648, US

(21) Appl. No.: 12/324,353

(22) Filed: Nov. 26, 2008

Related U.S. Application Data
(60) Provisional application No. 60/990,230, filed on Nov. 26, 2007.

(51) Int. Cl. G06Q 30/00

(52) U.S. Cl. 705/14

(57) ABSTRACT

Systems and methods are provided herein that provide for vehicular advertisements.

### RELATED REFERENCES

This application claims priority to U.S. Provisional Application 60/990,230 entitled “Vehicular Advertisement System and Method” filed Nov. 26, 2007. The foregoing application is hereby incorporated by reference in its entirety as if fully set forth herein.

### FIELD

This invention relates generally to advertising, and more specifically, to systems and methods for providing vehicular advertisements.

### BACKGROUND

Ever since vehicles have existed, people have used vehicles to express themselves, which includes both personal and commercial expressions. Bumper stickers, for example are one simple method by which vehicle drivers express themselves and the content of such stickers can include humorous sayings, religious messages, group affiliations or a promotion for a business or other organization. Commonly, while stickers that promote businesses and other organizations benefit the business, the person who displays such a sticker on their vehicle typically receives no compensation for the advertisement.

On the other hand, some drivers are paid to display advertisements on their vehicles, which can include signs, billboards, and even vinyl wrap advertisements that can cover an entire vehicle. Many of these drivers can receive compensation for driving their vehicles during normal use or driving a designated route. Such vehicular advertisements are deficient primarily because they are static, and the advertisements cannot be changed on a regular basis. As a result, the displayed advertisement cannot be targeted to a specific area where the vehicle is being driven. Moreover, it is difficult to monitor drivers of vehicles with advertisements, and it is possible that the driver does not drive the vehicle frequently or that the driver does not drive in areas where potential customers would see the advertisements.

Additionally, drivers who wish to express themselves personally suffer the limitations of having stickers, posters or signs affixed to their vehicles that are static and lack the ability to change. Specifically, a driver may be able to express themselves generally, but cannot display transient expressions such as their present mood, a message to other drivers, or a need for emergency assistance. Similarly, public emergency alert systems may be able to display emergency alerts on a limited number of billboards along highways, but are unable to alert drivers that do not pass these few billboards on the road. Clearly, the transient nature of emergency alerts makes it impractical to disseminate the alert via static vehicle based advertisements.

### BRIEF DESCRIPTION OF THE DRAWINGS

The present invention will be described by way of exemplary embodiments but not limitations, illustrated in the accompanying drawings in which like references denote similar elements, and in which:

FIG. 1 is a pictorial diagram of a system of interconnected devices, in accordance with various embodiments.

FIG. 2 is an environmental view of a vehicle and a display device, in accordance with various embodiments.

FIG. 3 is a block diagram of a device that provides an exemplary operating environment for various embodiments.

FIG. 4 is a diagram illustrating the actions taken by a user device, an advertising server, a display device, and an emergency alert server in accordance with various embodiments.

FIG. 5 is a flow diagram illustrating an advertisement selection routine in accordance with various embodiments.

FIG. 6 is a flow diagram illustrating an advertisement presentation routine, in accordance with various embodiments.

FIG. 7 is a flow diagram illustrating a further advertisement presentation routine, in accordance with various embodiments.

FIG. 8 is a diagram illustrating the actions taken by a user device, an advertising server, a cellular telephone, and a display device in accordance with various embodiments.

### DESCRIPTION

Illustrative embodiments presented herein include, but are not limited to, systems and methods for providing vehicular advertisements.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

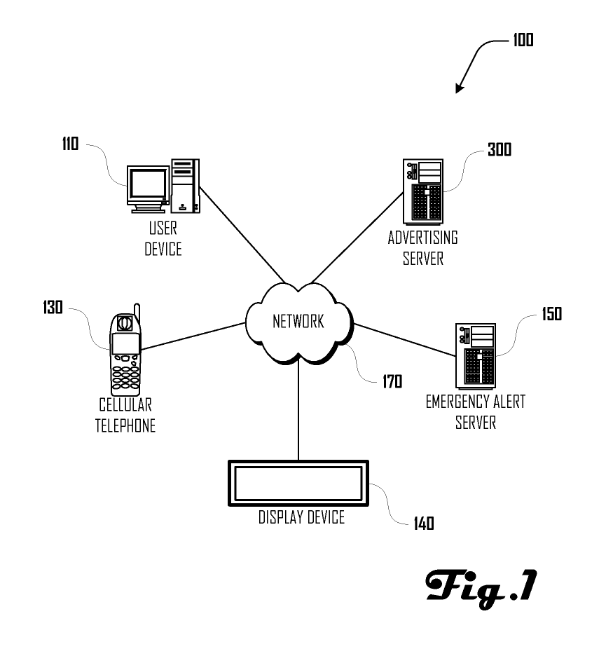

FIG. 1 is a pictorial diagram of a system of interconnected devices 100, in accordance with various embodiments, which comprises a user device 110, an advertising server 300, a cellular telephone 130, an emergency alert server 150 and a display device 140, which are all operationally connected via a network 170. In one embodiment the cellular telephone 130 or user device 110 can be various types of devices that can communicate information and it should be clear to one of ordinary skill in the art that a cellular telephone 130 and depiction of a desktop computing system are used herein as examples of two such devices that can be used, which could alternatively be a personal data assistant, global positioning system, computer, laptop computer, or the like.

In one embodiment the display device 140 can be a device that is capable of presenting a display, which can include a cathode ray tube, a projector, mechanical display, segment display, or a digital display such as a bistable display, electronic paper, vacuum fluorescent display (“VFD”), light emitting diode (“LED”) display, plasma display panel (“PDP”), liquid crystal display (“LCD”), organic light-emitting diode display (“OLED”), surface-conduction electron-emitter display (“SED”), laser television display, carbon nanotube display, nanocrystal display, electrophoretic display, or the like. In a further embodiment, a converter can be located near or embodied in the display device 140.

In yet another embodiment, the emergency alert server 150 can be associated with an organization or alert system such as the “America's Missing: Broadcasting Emergency Response” (“AMBER”) alert system, the National Oceanic and Atmospheric Administration (“NOAA”), the United States Department of Homeland Security (“DHS”); a Humane Society, a state, local or federal law enforcement agency, or the like. In a still further embodiment, one or more of the user device 110, advertising server 300, cellular telephone 130, emergency alert server 150 and display device 140 can be absent, or there can be a plurality of any of these devices, which can be in proximate or disparate locations compared to each other.

In one embodiment, various types of a network 170 can be used to operationally connect the user device 110, advertising server 300, cellular telephone 130, emergency alert server 150, and display device 140. Additionally, one or more network 170 can be employed within the scope of one embodiment. For example, a local area network (“LAN”), wireless local area network (“WLAN”), personal area network (“PAN”), Worldwide Interoperability for Microwave Access (“WiMax”), telephone network, pager network, powerline connection, serial bus, universal serial bus (“USB”) wireless connection, or the like

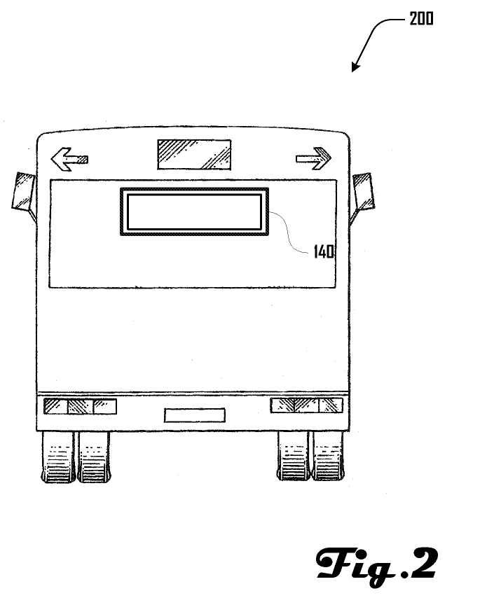

FIG. 2 is an environmental view of a vehicle 200 and a display device 140, in accordance with various embodiments. FIG. 2 depicts an embodiment where a rectangular display device 140 is mounted to the rear window of a vehicle 200, namely a bus. In another embodiment, the vehicle 200 can be various types of vehicle, including a car, truck, motorcycle, boat or the like. In one embodiment, the display device 140 can be positioned in various locations inside, outside, or integrated within a vehicle 200. For example, in another embodiment, a display device 140 can be coupled to the inside or outside of a vehicle, a display device 140 can be integrated into various parts of a vehicle, or an existing device or part of a vehicle can be uses as a display device (e.g. the light strip on a Cadillac Escalade®).

In a further embodiment, a display device 140 can be mounted or otherwise associated or coupled to various objects in various locations. For example, a display device 140 can be coupled to a backpack or article of clothing and be carried by a user wearing said backpack or article of clothing. In another example, a display device 140 can be coupled to a window of a residence or business or can be in a location where a billboard, sandwich board, or other advertisement would commonly be positioned. Additionally, although the display device 140 is depicted herein as being a rectangular display, one of ordinary skill in the art will appreciate that a display can be various sizes or shapes in various embodiments of the invention.

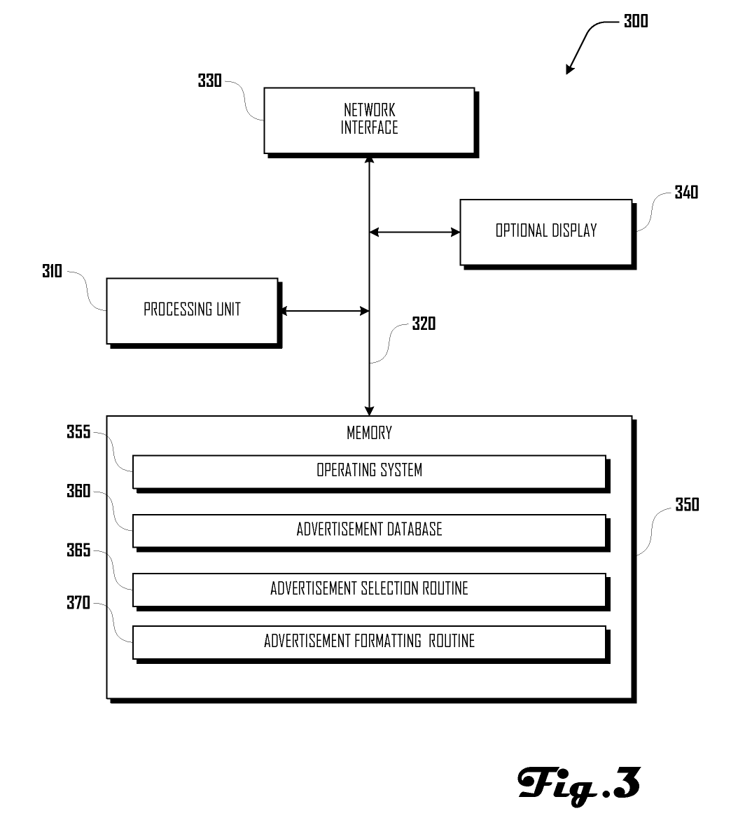

FIG. 3 illustrates several components of an exemplary operating environment 300 for an embodiment. For example, an advertising server 300 can be embodied in the operating environment 300 depicted in FIG. 3, and in other embodiments a user device 110, emergency alert server 150, cellular telephone 130 or display device 140 can be embodied in the operating environment 300 depicted in FIG. 3. Those of ordinary skill in the art and others will appreciate that the operating environment 300 may include many more components than those shown in FIG. 3. However, it is not necessary that all of these generally conventional components be shown in order to disclose an enabling embodiment for practicing the embodiments described herein. As shown in FIG. 3, the operating environment 300 includes a network interface 330 for connecting to remote devices (not shown). The network interface 330 may be a network interface designed to support a local area network (“LAN”), wireless local area network (“WLAN”), personal area network (“PAN”), Worldwide Interoperability for Microwave Access (“WiMax”), telephone network, pager network, powerline connection, serial bus, universal serial bus (“USB”) wireless connection, or the like. The network interface 330 includes the necessary circuitry, driver and/or transceiver for such a connection and is constructed for use with the appropriate protocols for such a connection.

The operating environment 300 also includes a processing unit 310, an optional display 340 and a memory 350, all interconnected along with the network interface 330 via a bus 320. Those of ordinary skill in the art and others will appreciate that the display 340 may not be necessary in all forms of computing devices and, accordingly, is an optional component. The memory 350 generally comprises random access memory (“RAM”), a read only memory (“ROM”) and a permanent mass storage device, such as a disk drive, flash RAM, or the like. The memory 350 stores the program code necessary for an advertisement selection routine 365 and an advertisement formatting routine 370. Additionally, the memory 350 stores an operating system 355 and an advertisement database 360.

It will be appreciated that the software components may be loaded from a computer readable medium into memory 350 of the operating environment 300 using a drive mechanism (not shown) or network mechanism (not shown) associated with the computer readable medium, such as a floppy, tape, digital video disc (DVD)/CD-ROM drive, flash RAM, network interface card, or the like.

Although an exemplary operating environment 300 has been described that generally conforms to conventional general-purpose computing device, those of ordinary skill in the art will appreciate that a operating environment 300 may be any of a great number of devices capable of functioning as a device, server or operating environment that is within the spirit or scope of the embodiments described herein or can perform at least one function of the embodiments described herein.

In one exemplary embodiment, a user device 110 can configure or interact with the operating environment 300 using a graphical user interface. An example of a graphical user interface is an interactive web page, e.g., in HTML (HyperText Markup Language), Flash, JavaScript, VBScript, JScript, ASP.NET, PHP (HTML Preprocessor) or XHTML (eXtensible HyperText Markup Language) form, or the like. Resultantly, since users are generally familiar with the user interfaces of web pages, including sophisticated web pages such as Flash-enabled web pages from Macromedia, Incorporated of San Francisco, Calif., consumption of peer to peer device services using a web page based graphical user interface on a peer to operating environment 300 (e.g., displayed on the peer to peer display 340) may be made familiar and user friendly.

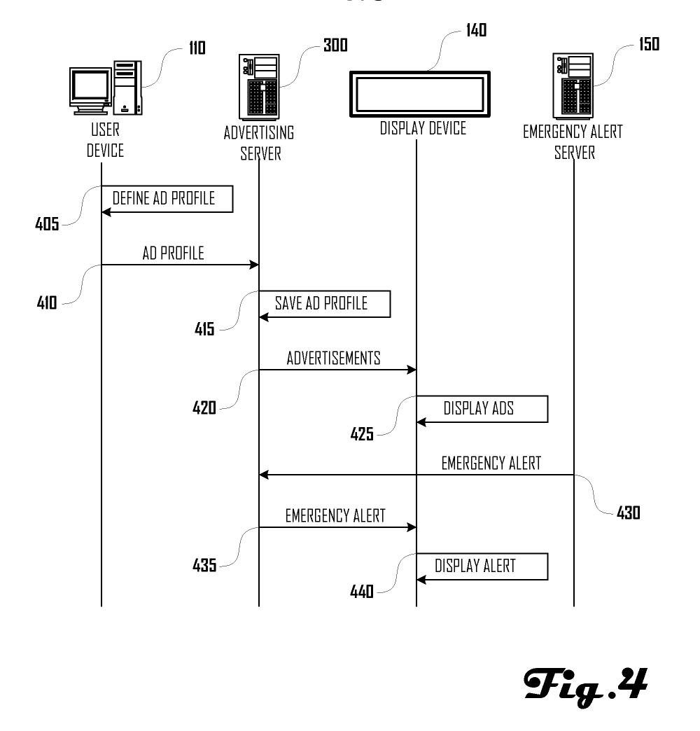

FIG. 4 is a diagram illustrating the actions taken by a user device 110, an advertising server 300, a display device 140, and an emergency alert server 150 in accordance with various embodiments. The actions begin where a user defines 405 an advertising profile and sends 410 the advertising profile information to the advertising server 300, where the advertising server 300 saves 415 the advertisement profile. For example, a user can use a website to define types of advertisements the user desires to have presented on a display device 140 associated with the user. In one embodiment, a user can select advertisements from specific service providers or product providers or can select categories of service or product providers that the user desires or does not desire to have displayed on a display device 140 associated with the user. For example, users may desire to have advertisements from their favorite product provider be displayed, or may desire not to have certain types of products such as tobacco or alcohol displayed on a display device 140 associated with them. Additionally, in another embodiment, a user can elect to receive alerts or advertisements from an emergency alert server 150.

Returning to FIG. 4, the advertising server 300 can send 420 advertisements to the display device 140 and the display device 140 can display 425 the advertisements. In one embodiment, the advertising server 300 can send 420 advertisements that conform to criteria defined 405 by a user in an advertisement profile. In another embodiment, the advertising server 300 can send 420 one or more advertisement to the display device 140 at a given time and can send 420 one or more advertisement at any temporal interval. For example, the advertising server 300 can continuously send 420 advertisements such that one advertisement is displayed 425 on the display device 140 every minute.

Additionally, in a further embodiment, regional or local advertising servers 300 can be used to distribute advertisements. For example, in one embodiment, a display device 140 traveling within range of a first wireless network can connect to the first wireless network and display 425 advertisements sent 420 from the first wireless network and when the display device 140 travels in range of a second wireless network the display device 140 can connect to the second wireless network and display 425 advertisements sent 420 from the second wireless network.

Again returning to FIG. 4, an emergency alert server 150 can send 430 an emergency alert to the advertising server 300, and the advertising server 300 can send the emergency alert 435 to the display device 140 and the display device 140 can display 440 the alert. For example, in one embodiment, the emergency alert server 150 can send 430 out an AMBER Alert when such an alert is issued, which can be displayed 440 on multiple display devices 140. Alternatively, in another embodiment, when a law enforcement agency is searching for a suspect or desires to alert the public to a safety hazard, the law enforcement agency can issue an emergency alert, which can be displayed 440 on multiple display devices 140. Additionally, in a still further embodiment, a local, regional, or national Humane Society can send 430 out an alert regarding lost or distressed animals, animals in need of adoption or the like.

In a further embodiment, occupants of a vehicle can view advertisements on a display device 140, or can view advertisements on a device such as a GPS device, video screen, or the like. Additionally, in another embodiment, an occupant of a vehicle can interact with advertisements. For example, the occupant can request and be presented with additional information about a good or service advertised, request and be presented with directions to an advertised location, or request and be presented with other information such as a phone number, menu, catalogue, price list, movie time, theater location, or the like. In one example, theater times and locations can be presented to a user on a user device 140.

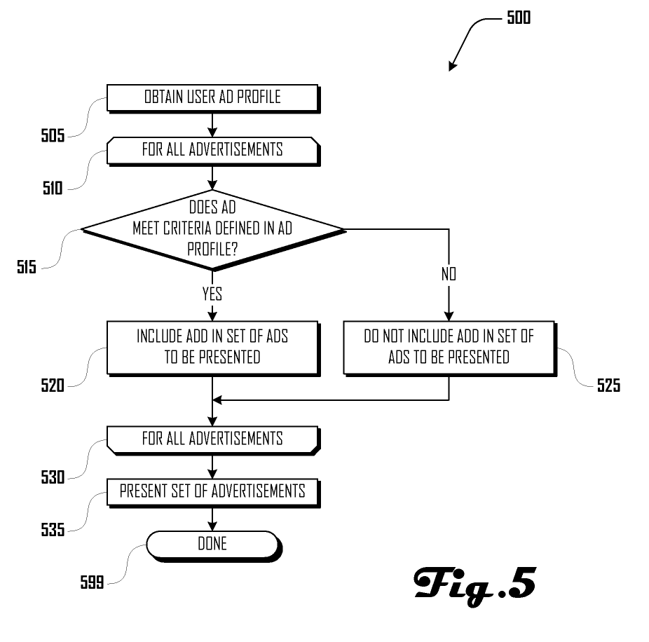

FIG. 5 is a flow diagram illustrating an advertisement selection routine 500 in accordance with various embodiments. The advertisement selection routine 500 begins in block 505 where a user advertising profile is received. Looping block 510 begins a loop, and the following actions are taken for all advertisements. A decision is made in decision block 515 whether a given advertisement meets a set of criteria defined by the user advertisement profile, and if the advertisement does meet the criteria, the advertisement selection routine 500 continues to block 520, where the advertisement is included in a set of advertisements to be presented and then continues to looping block 530, which ends the loop for all advertisements. However, if the advertisement does not meet the criteria defined in the user advertising profile, the advertisement selection routine 500 continues to block 525, where the advertisement is not included in the set of advertisements to be presented and then continues to looping block 530, which ends the loop for all advertisements. The set of advertisements is presented in block 535 and the routine 500 is done 599.

In one embodiment, a set of advertisements can be generated by an advertising selection routine 500 and presented sequentially or in random order. In a further embodiment, a set of advertisements can be sequentially or randomly proposed for presentation, but if a given advertisement does not meet advertising criteria as defined in a user advertising profile, the advertisement will not be displayed.

In another embodiment, various types of advertisement can be presented in various forms, which can include alphanumeric characters, graphics or the like. In one embodiment, an advertisement can include a promotional code which can be used to redeem an offer presented on an advertisement, and which can also be used to determine which display device 140 presented the given advertisement from which the successful redemption of the offer occurred. For example, each display device 140 could receive a unique promotional code that can be displayed in one or more advertisement displayed on a display device 140 associated with a user. When a person views the advertisement and subsequently uses the promotional code depicted in the advertisement, the user can receive revenue, credit or other incentive for originating a successful sale.

In another embodiment, a user or other entity can receive tax-deductable gift credit for displaying or choosing to display some advertisements, which can include advertisements from an emergency server, non-profit company, charity organization, or the like.

In yet another embodiment, a user can receive advertising revenue or other incentive when advertisements are presented on a display device 140 that is associated with the user. For example, in one embodiment, a user can receive money for each advertisement presented or for time that advertisements are presented. In another exemplary embodiment, a user can receive rebates or credits that can be used to purchase products or services from providers advertised on the user's display device 140 or from other providers. In a still further embodiment, a user can be paid a flat-rate per day, week, month, year, or the like for displaying advertisements.

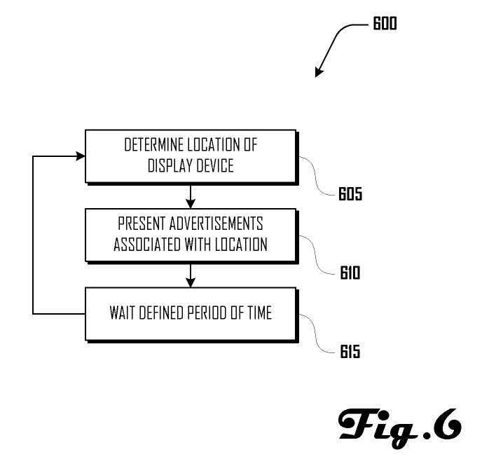

FIG. 6 is a flow diagram illustrating an advertisement presentation routine 600, in accordance with various embodiments. In block 605, the location of a display device 140 is determined, and in block 610 advertisements associated with the determined location are presented on the display device 140. A defined period of time is allowed to expire in block 615, and the advertisements presentation routine 600 cycles back to block 605, where the location of the display device 140 is again determined.

In one embodiment, a global positioning system (“GPS”) device, system or the like can be used to determine the position of a display device 140 and advertisements that are relevant to the location of the display device 140 can be presented. In one example, where a vehicle is traveling on a highway, a GPS system can determine the location of the display device 140 and display advertisements for business that are located along the highway or are in close proximity to the display device 140. Furthermore, advertisements can be presented that comprise directions to advertised businesses that are in proximity to the location of the display device 140 (e.g. “Take Exit 212 and a left on Cortez Ave.” or “2 Miles Ahead on Broadway”).

In a further embodiment, advertisement revenue or incentives can be provided to a user associated with a display device 140 depending on the location of the display device 140 at the time advertisements are being displayed. For example, in a large metropolitan area, there is commonly a greater density of people that can view advertisements than in rural or backcountry areas. Accordingly, users associated with a display device 140 attached to their vehicle could receive more advertising revenue per advertisement when driving through New York City, as compared to driving through Nebraska farmland.

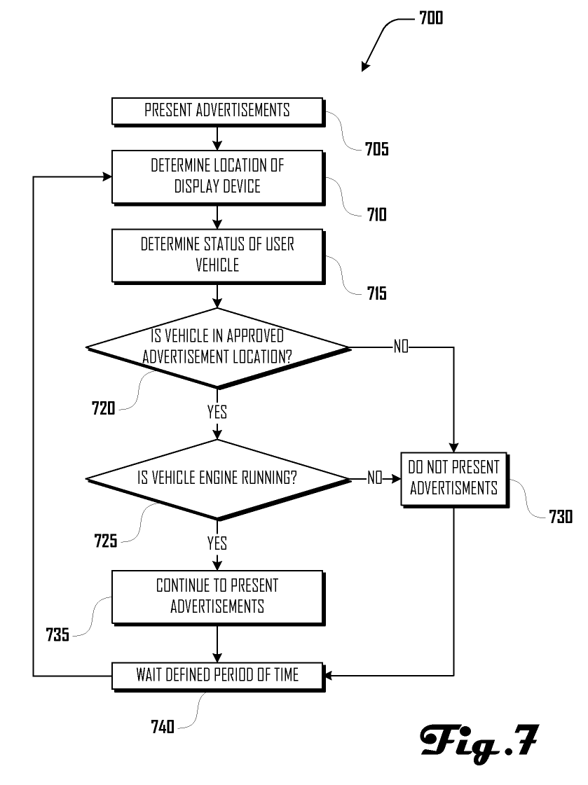

FIG. 7 is a flow diagram illustrating a further advertisement presentation routine 700, in accordance with various embodiments. In block 705 advertisements are presented on a display device 140 and in block 710 the location of the display device 140 presenting the advertisements is determined along with the status of the user's vehicle where the display device 140 is located in block 715. As described herein, a GPS device or system and the like can be used to determine the location of a given display device 140. In block 720, a determination is made whether the vehicle is in an approved advertisement location and if it is not, the routine 700 continues to block 730, where advertisement presentation ceases.

For example, in one embodiment, certain locations can be defined as being a location where advertisements should not be displayed. State, local, or federal law may prohibit advertisements in certain areas, or advertisers may not want to pay users associated with a display device 140 for presenting advertisements in certain areas or the like. Accordingly, a display device 140 determined to be in such a location will not be sent advertisements to be presented. In a further embodiment, individual advertisements or types of advertisements can be selectively not presented in defined areas.

Returning to the advertising presentation routine 700, if a vehicle is determined to be in an approved advertisement location, the advertising presentation routine 700 continues to decision block 725 where a decision is made whether the vehicle's engine is running, and if the engine is not running, the advertising presentation routine 700 continues to block 730 where advertisements cease to be presented. If, however, the vehicle engine is determined to be running, advertisements continue to be presented in block 735. In block 740, a period if time is allowed to expire and the advertising presentation routine 700 cycles back to block 710, where the location of the display device 140 is again determined along with the status of the user vehicle in block 715.

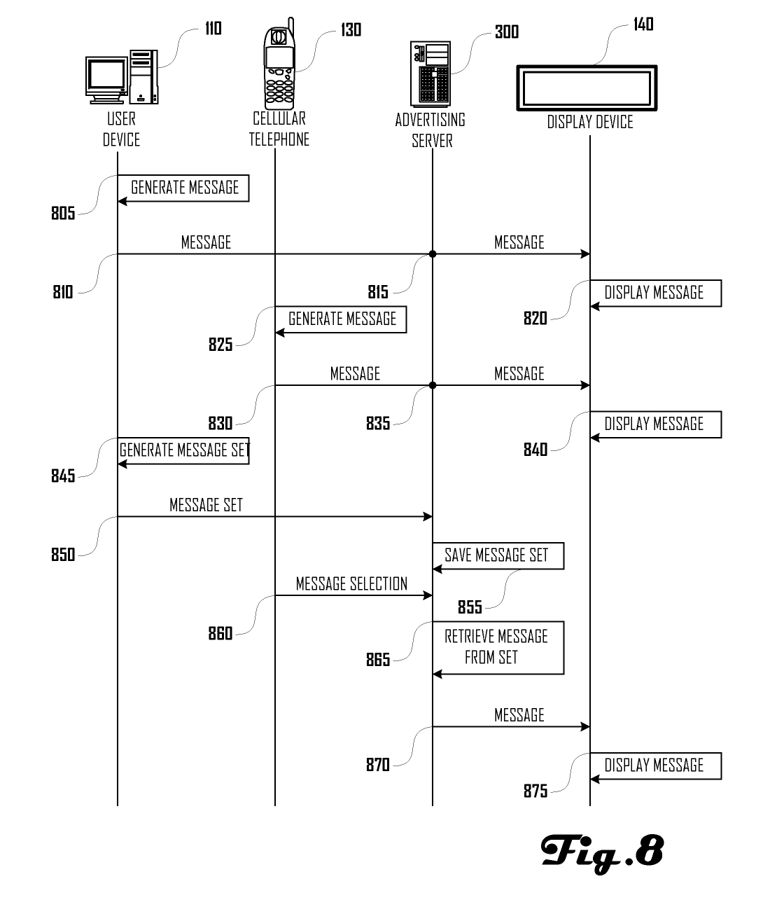

FIG. 8 is a diagram illustrating the actions taken by a user device 110, an advertising server 300, a cellular telephone 130, and a display device 140 in accordance with various embodiments. The actions begin where a user device 110 generates 805 a message, the message is sent 810 to the advertising server 300 and sent 815 to the display device 140, which displays 820 the message. In one embodiment, a user can generate 805 a message on a user device 110 that the user desires to display 820 on a display device 140, which can be a display device 140 associated with the user or any other display device 140. In another embodiment, a message can be displayed 820 among a set of advertisements. Similarly, a message can be generated 825 by the cellular telephone 130, sent 830 to the advertising server 300, and sent 835 to the display device 140 where the message can be displayed 840.

Returning to FIG. 8, a set of one or more message can be generated 845 and sent 850 to the advertising server 300 where the set of one or more message can be saved 855. Then, a selection of a message of the set is sent 860 from the cellular telephone 130 to the advertising server 300 and the advertising server 300 retrieves 865 the message and sends 870 the message to the display device 140, where the message is displayed 875.

For example, in one embodiment, a user can generate 805, 825, 845 a message or set of messages from a user device 110 or cellular telephone 130, and selectively display 820, 840, 875 a message on a display device 140, which can be coupled to a vehicle. A user can display personal messages to other vehicle drives (e.g. “Sorry I cut you off!”) or safety related messages (e.g. “need help, call 911”). Messages can be pre-programmed by a user or administrator or messages can be programmed by a user for immediate display.

In another embodiment, a user can purchase or otherwise obtain an advertisement card, which can be a computing device or memory device, and can come loaded with or store advertisements that can be displayed on a display device 140. Such a device can include a flash memory drive, a card with a magnetic strip, a compact disc, or the like. Alternatively, information can be loaded onto a computing device such as a cellular telephone, laptop computer, gaming device, music player, or the like. The advertisement card can be operationally connected to a display device either directly or via a network 170 and thereby present advertisements comprising the one or more advertisement stored therein. In one embodiment, the advertisement card can be embodied in a key-chain, key-tag, or the like.

In a further embodiment, an advertisement card can be configured to expire on a defined date, defined time, once a defined number of advertisements have been displayed, or at any other defined event or time period. Upon expiration of the advertisement card, a user can purchase or otherwise obtain a new advertisement card or can recharge the advertisement card by purchasing or otherwise obtaining new advertisements, more advertising time, resetting the expiration event or time, or the like. Recharging of the advertising card can be accomplished via the internet, a network 170, at a store or other businesses establishment, a kiosk, or the like. In a yet further embodiment, a user can receive cash, a credit, a discount, or other incentive for displaying advertisements via an advertising card, and such incentive can be provided upon obtaining the advertisement card, when the advertisement card is recharged or turned-in, at a defined regular interval, or at various other defined times or events. For example, in another embodiment, a record of an earned incentive can be stored by a retailer and disclosed and redeemed when the customer that earned the incentive makes a purchase with the retailer.

For example, a retail store can offer advertisement cards to customers with advertisements for the retail establishment that can be of a temporary or permanent nature (e.g. a limited sale compared to a general advertisement). The retail store can offer store credit or a discount on merchandise when the customer returns the expired advertising card. In another embodiment, there can be a kiosk where users can obtain an advertising card, load advertisements onto a computing device, view the status of an advertising card, recharge an advertising card, or the like.

Additionally, although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. While various embodiments have been illustrated and described, as noted above, many changes can be made without departing from the spirit and scope of the embodiments described herein. Accordingly, the scope of the invention is not limited by the disclosure of these embodiments.

1. Systems and methods for vehicular advertisements as shown and described herein.
